(19) United States
(12) Patent Application Publication
(10) Pub. No.: US 2015/0163386 A1
(43) Pub. Date: Jun. 11, 2015

(54) CAMERA MODULE

(71) Applicant: SAMSUNG ELECTRO-MECHANICS CO., LTD., Suwon-si (KR)

(72) Inventors: Po Chul Kim, Suwon-si (KR); Jae Ho Baik, Suwon-si (KR); Woon Ki Kim, Suwon-si (KR); Myung Ki Lee, Suwon-si (KR); Chuel Jin Park, Suwon-si (KR); Jae Hyuk Lee, Suwon-si (KR); Ki Mun Paik, Suwon-si (KR); Jung Seok Lee, Suwon-si (KR)

(73) Assignee: SAMSUNG ELECTRO-MECHANICS CO., LTD., Suwon-si (KR)

(21) Appl. No.: 14/187,931

(22) Filed: Feb. 24, 2014

(30) Foreign Application Priority Data
Dec. 9, 2013 (KR) 10-2013-0152309

(51) Int. Cl. H04N 5/225; H04N 5/33

(52) U.S. Cl. CPC H04N 5/2257; H04N 5/2254; H04N 5/33

(57) ABSTRACT

There is provided a camera module including: a housing having a lens barrel disposed therein; an infrared filter attached to an inner surface of the housing and disposed below the lens barrel; and a board coupled to a lower portion of the housing and having an image sensor mounted thereon, wherein the board has a plurality of terminals formed thereon, the image sensor has a plurality of bonding pads formed therein, and the plurality of bonding pads are electrically connected to the plurality of terminals by bonding wires, respectively, and the plurality of bonding pads have a coating material applied thereto in order to absorb external light incident thereto.

### CROSS-REFERENCE TO RELATED APPLICATION

This application claims the benefit of Korean Patent Application No. 10-2013-0152309 filed on Dec. 9, 2013, with the Korean Intellectual Property Office, the disclosure of which is incorporated herein by reference.

### BACKGROUND

The present disclosure relates to a camera module.

Recently, portable communications terminals such as cellular phones, personal digital assistants (PDA), portable personal computers (PC), and the like, have generally been implemented with the ability to perform the transmission of image data in addition to text and audio data.

In accordance with this trend, camera modules have come to be standard components in portable communications terminals in order to enable the transmission of the image data as well as allow for functions such as video chatting, and the like.

The camera module may be provided with an image sensor, capture an image of a subject through the image sensor and, store the captured image as data in a memory in an apparatus, and the stored data may be displayed as an image on a display provided in the apparatus.

The image sensor may be electrically connected to a board on which the image sensor is mounted by a bonding wire.

In this case, light passing through a lens may be reflected onto a wire bonding pad provided in the image sensor, be re-reflected onto internal components in the camera module, and then be incident to the image sensor.

In this case, a flare phenomenon such as light blurring, or the like, may occur, which may have a negative influence on image quality. Therefore, there is a need to prevent reflected light in the camera module from being introduced into the image sensor.

### SUMMARY

An aspect of the present disclosure may provide a camera module capable of preventing external light from passing through a lens from being reflected on a bonding pad of an image sensor or a terminal of a board.

An aspect of the present disclosure may also provide a camera module capable of preventing corrosion of a bonding pad of an image sensor or the permeation of moisture into the bonding pad of the image sensor.

According to an aspect of the present disclosure, a camera module may include: a housing having a lens barrel disposed therein; an infrared filter attached to an inner surface of the housing and disposed below the lens barrel; and a board coupled to a lower portion of the housing and having an image sensor mounted thereon, wherein the board has a plurality of terminals formed thereon, the image sensor has a plurality of bonding pads formed therein, and the plurality of bonding pads are electrically connected to the plurality of terminals by bonding wires, respectively, and the plurality of bonding pads have a coating material applied thereto in order to absorb external light incident thereto.

The housing may have a protrusion part formed on the inner surface thereof, and the infrared filter may be attached to the protrusion part.

The coating material may be applied to surfaces of the respective bonding pads.

The coating material may cover surfaces of the respective bonding pads and portions of the bonding wires.

The coating material may be continuously applied along edges of the image sensor while covering surfaces of the plurality of bonding pads.

The coating material may be black.

The coating material may be prepared by adding a black pigment to a plastic resin.

The coating material may also be applied to the plurality of terminals so as to absorb external light incident to the plurality of terminals.

The coating material may be continuously applied along the plurality of terminals while covering surfaces of the plurality of terminals.

According to another aspect of the present disclosure, a camera module may include: a housing having a lens barrel disposed therein; an infrared filter attached to an inner surface of the housing and disposed below the lens barrel; and a board coupled to a lower portion of the housing and having an image sensor mounted thereon, wherein the board has a plurality of terminals formed thereon, the image sensor has a plurality of bonding pads formed therein, and the plurality of bonding pads are electrically connected to the plurality of terminals by bonding wires, respectively, and the plurality of bonding pads have a black ultraviolet (UV) curable resin applied thereto in order to absorb external light incident thereto.

The black UV curable resin may cover surfaces of the respective bonding pads and portions of the bonding wires.

The black UV curable resin may be continuously applied along edges of the image sensor while covering surfaces of the plurality of bonding pads.

The black UV curable resin may also be applied to the plurality of terminals so as to absorb external light incident to the plurality of terminals.

The black UV curable resin may be continuously applied along the plurality of terminals while covering surfaces of the plurality of terminals.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view of a camera module according to an exemplary embodiment of the present disclosure;

FIG. 2A is a schematic cross-sectional view showing a form in which external light passing through a lens is reflected on a bonding pad of an image sensor;

FIG. 2B is a partially enlarged cross-sectional view of part A of FIG. 1;

FIG. 2C is a partially enlarged cross-sectional view showing a form in which a coating material is applied to both of a plurality of terminals formed on a board and a plurality of bonding pads formed on an image sensor;

FIG. 3 is a plan view showing a form in which a coating material is applied to a plurality of bonding pads formed on an image sensor;

FIG. 4 is a plan view showing a form in which a coating material is applied to both of a plurality of terminals formed on a board and a plurality of bonding pads formed on an image sensor; and

FIG. 5 is a plan view of an image sensor and a board showing a modified example of a coating material according to an exemplary embodiment of the present disclosure.

### DETAILED DESCRIPTION

Exemplary embodiments of the present disclosure will now be described in detail with reference to the accompanying drawings.

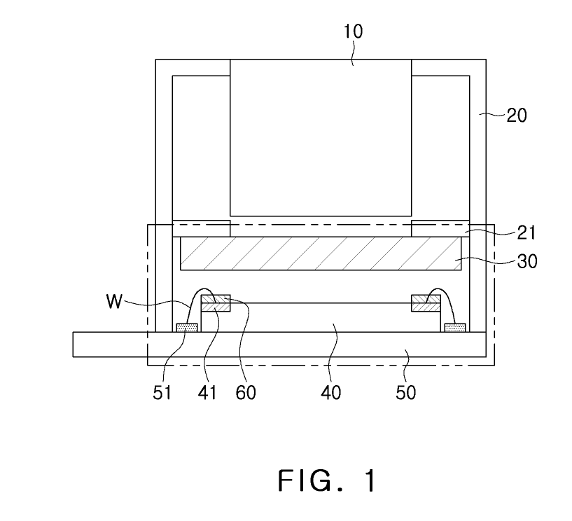

FIG. 1 is a schematic cross-sectional view of a camera module according to an exemplary embodiment of the present disclosure.

Referring to FIG. 1, a camera module according to an exemplary embodiment of the present disclosure may include a lens barrel 10, a housing 20, an infrared filter 30, an image sensor 40, and a board 50.

First, terms with respect to directions will be defined. An optical axis direction refers to a vertical direction based on the lens barrel 10.

The lens barrel 10 may have a hollow cylindrical shape so that at least one lens imaging a subject may be accommodated therein, wherein the lens may be disposed in the lens barrel 10 on the optical axis.

The lens barrel 10 may be coupled to the housing 20. In detail, the lens barrel 10 may be disposed in the housing 20.

Here, the lens barrel 10 may be moved in the optical axis direction for auto-focusing.

In order to move the lens barrel 10 in the optical axis direction, an inner portion of the housing 20 may be provided with an actuator (not shown) including a voice coil motor.

However, a moving unit of the lens barrel 10 is not limited to the actuator (not shown) including the voice coil motor (VCM). That is, various schemes such as a mechanical driving scheme, a piezoelectric driving scheme using a piezoelectric element, or the like, may be used.

The lens barrel 10 may be moved by the operation as described above to perform an auto focusing or zooming function.

Meanwhile, although not shown in FIG. 1, a case may be coupled to the housing 20 so as to surround an outer surface of the housing 20.

The case may serve to shield electromagnetic waves generated during driving the camera module.

The image sensor 40, which collects light incident through the lens barrel 10 to generate an image signal, may be formed of complementary metal oxide semiconductor (CMOS) sensor or a charge coupled device (CCD) sensor.

An image of the subject may be captured by the image sensor 40 and be stored as data on a memory in an apparatus, and the stored data may be displayed as the image by a display medium in the apparatus.

The image sensor 40 may be mounted on the board 50 and be electrically connected to the board 50 by a bonding wire (W).

The image sensor 40 may have a plurality of bonding pads 41 formed thereon, and the board 50 may have a plurality of terminals 51 formed thereon.

The plurality of bonding pads 41 and the plurality of terminals 51 may be electrically connected to each other by bonding wires W, respectively.

The plurality of bonding pads 41 may be disposed at edges of the image sensor 40.

The board 50 having the image sensor 40 mounted thereon may be coupled to a lower portion of the housing 20.

Here, the lens barrel 10 and the image sensor 40 may have the infrared filter 30 disposed therebetween.

For example, the infrared filter 30 may be attached to an inner surface of the housing 20 and be disposed below the lens barrel 10.

The housing 20 may have a protrusion part 21 formed on the inner surface thereof, a window through which external light L passes may be formed by the protrusion part 21, and the infrared filter 30 may be attached to the protrusion part 21.

An infrared ray in the external light L may be cut off while the external light L passing through the lens passes through the infrared filter 30. Therefore, introduction of the infrared ray into the image sensor 40 may be prevented.

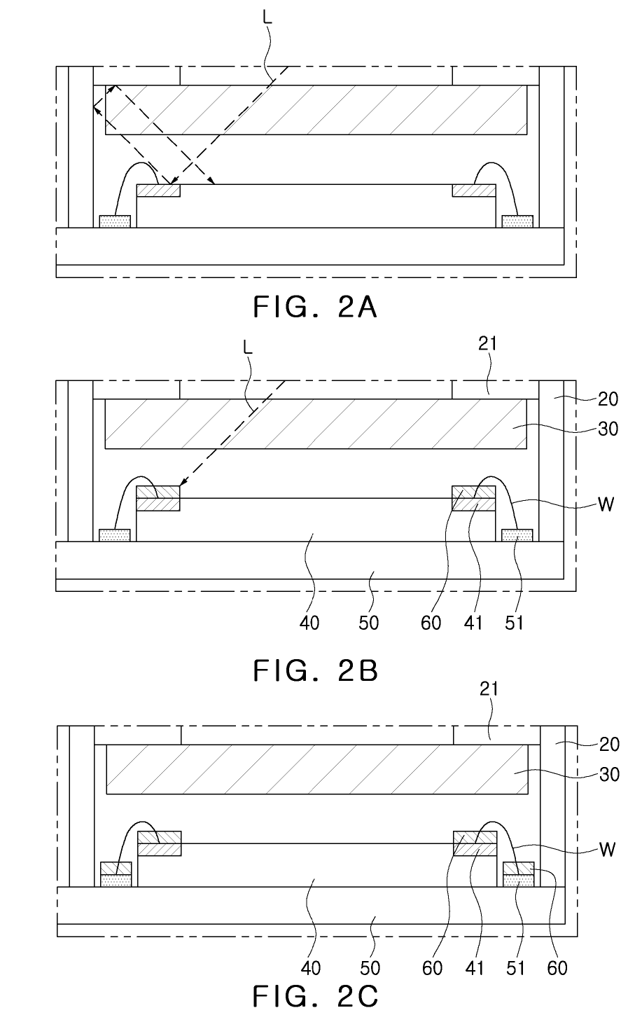

A coating material 60 may be applied to the plurality of bonding pads 41 provided on the image sensor 40, which will be described in detail with reference to FIGS. 2A through 4.

FIG. 2A is a schematic cross-sectional view showing a form in which external light passing through a lens is reflected on a bonding pad of an image sensor; FIG. 2B is a partially enlarged cross-sectional view of part A of FIG. 1; and FIG. 2C is a partially enlarged cross-sectional view showing a form in which a coating material is applied to both of a plurality of terminals formed on a board and a plurality of bonding pads formed on an image sensor.

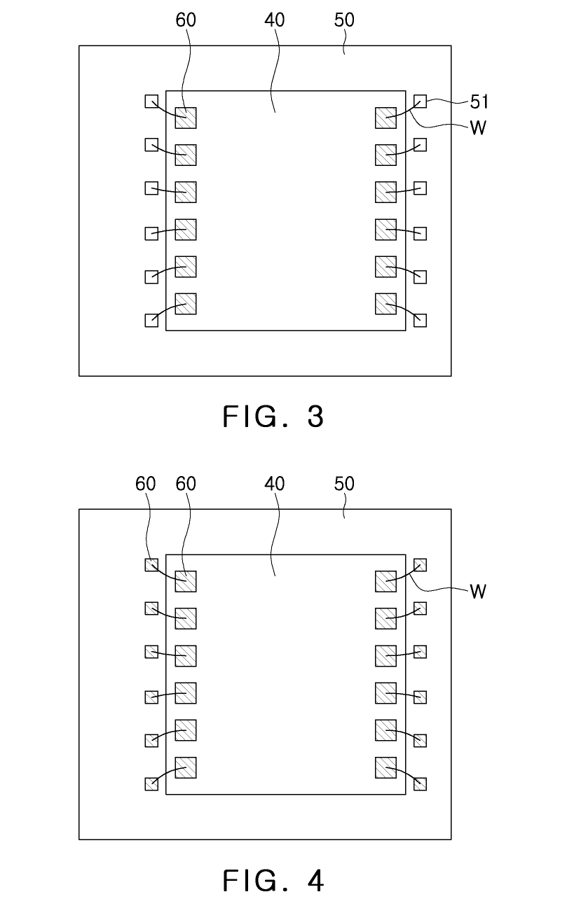

In addition, FIG. 3 is a plan view showing a form in which a coating material is applied to a plurality of bonding pads formed on an image sensor.

Further, FIG. 4 is a plan view showing a form in which a coating material is applied to both of a plurality of terminals formed on a board and a plurality of bonding pads formed on an image sensor.

A flare phenomenon occurring due to external light passing through a lens being reflected by a bonding pad of an image sensor will be described with reference to FIG. 2A.

The external light passing through the lens may be incident to the image sensor through the infrared filter.

Here, the external light may be reflected on the plurality of bonding pads disposed on the edges of the image sensor, and the reflected external light may be again reflected on the protrusion part of the housing and be then incident to the image sensor.

In the case in which light is reflected or scattered in an optical apparatus such as a camera module, images of a subject that is originally to be observed may be overlapped with each other, such that image quality may be deteriorated.

That is, the light scatter-reflected and then arriving at the image sensor may cause a flare phenomenon such as light blurring, or the like to have a bad effect on the image quality.

Therefore, as shown in FIG. 2B, the camera module according to an exemplary embodiment of the present disclosure may include the coating material 60 absorbing the external light L incident to the plurality of bonding pads 41.

For example, the coating material 60 may be applied to the plurality of bonding pads 41 to absorb the external light L arriving at the plurality of bonding pads 41, thereby preventing the light from being reflected or scattered in the camera module. As a result, the flare phenomenon may be prevented.

Referring to FIGS. 2B and 3, the coating material 60 may be applied to surfaces of the respective bonding pads 41.

The coating material 60 may cover portions of the bonding wires W while covering the surfaces of the respective bonding pads 41.

Therefore, the coating material 60 may also prevent the external light L from being reflected on the bonding wires W.

Since the coating material 60 should cover portions of the bonding wires W, it may be preferable that the coating material 60 is applied to the bonding pads 41 after the bonding wires W are connected to the plurality of bonding pads 41, respectively.

Meanwhile, the coating material 60 may be black so as to absorb the external light L. For example, the coating material 60 may be prepared by adding a black pigment to a plastic resin.

In addition, the coating material 60 may be a black ultraviolet (UV) curable resin.

In the case in which the black UV curable resin is applied to the respective bonding pads 41 and is then irradiated with ultraviolet rays to thereby be cured, the bonding pads 41 and portions of the bonding wires W may be covered by the black UV curable resin.

Since the coating material 60 covers the surfaces of the respective bonding pads 41, corrosion of the bonding pads 41 or the permeation of moisture into the bonding pads 41 may be prevented.

Meanwhile, referring to FIGS. 2C and 4, the coating material 60 may also be applied to the plurality of terminals 51 formed on the board 50.

Since the external light L passing through the lens may be incident to and reflected on the plurality of terminals 51 formed on the board 50 as well as the plurality of bonding pads 41 formed on the image sensor 40, the coating materials 60 may also be applied to the plurality of terminals 51 so as to absorb the external light incident to the plurality of terminal 51.

The coating materials 60 may be applied on surfaces of the respective terminals 51.

The coating material 60 may cover portions of the bonding wires W while covering the surfaces of the respective terminals 51.

Therefore, the coating material 60 may also prevent the external light L from being reflected on the bonding wires W.

Since the coating material 60 should cover portions of the bonding wires W, it may be preferable that the coating material 60 is applied to the terminals 51 after the bonding wires W are connected to the plurality of terminals 51, respectively.

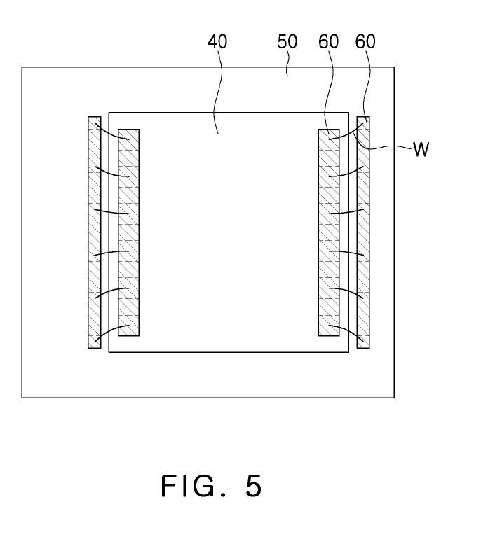

FIG. 5 is a plan view of an image sensor and a board showing a modified example of a coating material according to an exemplary embodiment of the present disclosure.

Referring to FIG. 5, the coating material 60 according to an exemplary embodiment of the present disclosure may be continuously applied along the edges of the image sensor 40 while covering the surfaces of the plurality of bonding pads 41.

Although the case in which the coating material 60 is applied to the surface of the respective bonding pads 41 has been described in the above-mentioned exemplary embodiment of the present disclosure, the coating material 60 may be continuously applied along the edges of the image sensor 40 while covering the surfaces of the plurality of bonding pads 41 in this exemplary embodiment.

In addition, in the case in which the coating material 60 is also applied to the plurality of terminals 51, the coating material 60 may be continuously applied along the plurality of terminals 51 while covering the surfaces of the plurality of terminals 51.

As set forth above, the camera module according to an exemplary embodiment of the present disclosure may prevent the external light passing through the lens from being reflected on the bonding pad of the image sensor or the terminal of the board, thereby preventing the flare phenomenon.

In addition, the corrosion of the bonding pad of the image sensor or the permeation of the moisture into the bonding pad may be prevented.

While exemplary embodiments have been shown and described above, it will be apparent to those skilled in the art that modifications and variations could be made without departing from the spirit and scope of the present disclosure as defined by the appended claims.

What is claimed is:

1. A camera module comprising:
a housing having a lens barrel disposed therein;
an infrared filter attached to an inner surface of the housing and disposed below the lens barrel; and
a board coupled to a lower portion of the housing and having an image sensor mounted thereon,
wherein the board has a plurality of terminals formed thereon, the image sensor has a plurality of bonding pads formed therein, and the plurality of bonding pads are electrically connected to the plurality of terminals by bonding wires, respectively, and
the plurality of bonding pads have a coating material applied thereto in order to absorb external light incident thereto.

2. The camera module of claim 1, wherein the housing has a protrusion part formed on the inner surface thereof, and the infrared filter is attached to the protrusion part.

3. The camera module of claim 1, wherein the coating material is applied to surfaces of the respective bonding pads.

4. The camera module of claim 1, wherein the coating material covers surfaces of the respective bonding pads and portions of the bonding wires.

5. The camera module of claim 1, wherein the coating material is continuously applied along edges of the image sensor while covering surfaces of the plurality of bonding pads.

6. The camera module of claim 1, wherein the coating material is black.

7. The camera module of claim 1, wherein the coating material is prepared by adding a black pigment to a plastic resin.

8. The camera module of claim 1, wherein the coating material is also applied to the plurality of terminals so as to absorb external light incident to the plurality of terminals.

9. The camera module of claim 8, wherein the coating material is continuously applied along the plurality of terminals while covering surfaces of the plurality of terminals.

10. A camera module comprising:
a housing having a lens barrel disposed therein;
an infrared filter attached to an inner surface of the housing and disposed below the lens barrel; and
a board coupled to a lower portion of the housing and having an image sensor mounted thereon,
wherein the board has a plurality of terminals formed thereon, the image sensor has a plurality of bonding pads formed therein, and the plurality of bonding pads are electrically connected to the plurality of terminals by bonding wires, respectively, and
the plurality of bonding pads have a black ultraviolet (UV) curable resin applied thereto in order to absorb external light incident thereto.

11. The camera module of claim 10, wherein the black UV curable resin covers surfaces of the respective bonding pads and portions of the bonding wires.

12. The camera module of claim 10, wherein the black UV curable resin is continuously applied along edges of the image sensor while covering surfaces of the plurality of bonding pads.

13. The camera module of claim 10, wherein the black UV curable resin is also applied to the plurality of terminals so as to absorb external light incident to the plurality of terminals.

14. The camera module of claim 13, wherein the black UV curable resin is continuously applied along the plurality of terminals while covering surfaces of the plurality of terminals.
